(19) United States
(12) Patent Application Publication
(10) Pub. No.: US 2006/0272446 A1
(43) Pub. Date: Dec. 7, 2006

(54) Torsional vibration damper

(76) Inventors: Randall S. Cortright, South Lyon, MI (US); Douglas R. Farnsworth, Wixom, MI (US)

Correspondence Address: MCDONALD HOPKINS CO., LPA, 2100 BANK ONE CENTER, 600 SUPERIOR AVENUE, E., CLEVELAND, OH, 44114-2653, US

(21) Appl. No.: 11/412,520

(22) Filed: Apr. 27, 2006

Related U.S. Application Data
(60) Provisional application No. 60/675,224, filed on Apr. 27, 2005.

(51) Int. Cl. F16F 15/12

(52) U.S. Cl. 74/574.4

(57) ABSTRACT

A torsional vibration damper generally comprising a hub 15, which can be attached to an engine's crankshaft, two inertia members 20a and 20b, which provide the inertia necessary to control crankshaft torsional vibration, and two resilient members 25a and 25b, which allow for proper tuning of the damper's torsional frequencies. The two masses 20a,20b and resilient members 25a,25b allow for tuning two separate vibration frequencies, e.g. one for dampening one torsional peak and the other for dampening a second torsional peak.

### CROSS-REFERENCE TO RELATED APPLICATIONS

This application claims priority from U.S. Provisional Patent Application No. 60/675,224 filed on Apr. 27, 2005, which is hereby incorporated by reference.

### BACKGROUND

The present invention relates generally to a torsional vibration damper for dampening the vibration of a rotating shaft, for example, the crankshaft of an internal combustion engine, and more particularly, to a dual mass torsional vibration damper.

As is well known in the art, internal combustion engines, such as gasoline engines, are used to drive cars or other vehicles and the power of the reciprocating operation of the cylinders of the engine is transmitted to the wheels from one end of the crankshaft. The other end of the crankshaft is used to drive various auxiliary machinery such as alternators and power steering and air conditioning compressors through a pulley arrangement and one or more belts.

The crankshafts of internal combustion engines are subjected to considerable torsional vibration due to the sequential explosion of combustible gases in the cylinders. Further, the application of forces of rotation is not smooth and continuous. Unless controlled, the vibrations can often lead to failure of the crankshaft itself, and/or also contribute to failure in other parts of the engine or cooling system, particularly where resonance occurs. These vibrations also can cause noises such as a “whine” or knocking, both of which are highly undesirable.

For many years, these problems have been recognized and a variety of devices have been constructed and used to lessen the torsional vibrations. One common form of a torsional vibration damper comprises an inner metal hub attached to the end of the crankshaft, an outer metal annular member, and an elastomer member positioned between the hub and outer member. The outermost annular or ring member is often called the “inertia member”. The hub directly executes the vibrations created by the crankshaft because it is rigidly coupled to it. The inertia member is coupled to the hub by the elastomer and accordingly causes a phase lag between the oscillations of the hub and the corresponding oscillations of the inertia member.

It has been determined that many modes of vibration are produced by the rotating crankshaft of an engine. Torsional and bending are the two main modes of concern. Torsional vibration occurs angularly about the longitudinal axis of the crankshaft. The bending vibration mode is similar to the bending mode of a cantilevered beam. The fixed end of the crankshaft, or node, would be at some point within the engine crankcase. Conventional dynamic damping devices, such as the torsional damper devices described above, are not satisfactory to dampen or reduce such complex vibrations.

The field of art has attempted to dampen both torsional and bending vibrations utilizing several designs. Two such designs are disclosed in U.S. Pat. No. 5,231,893 and Great Britain Patent No. 2,250,567, both commonly assigned to the assignee of the present invention. The '893 patent utilizes a single inertia member to dampen torsional vibrations and utilizes changes in the radially outward or inward curvature of the hub and the single inertia member to dampen bending vibration. The '567 Great Britain patent utilizes a pair of annular inertia members mounted on various locations of the carrier wherein one annular inertia member is designed to dampen torsional vibration and the other annular inertia member is designed to dampen bending vibration.

It has been identified that several torsional peaks exist due to torsional vibration in a crankshaft. The common method for controlling torsional vibration on an engine with torsional peaks at lower and higher engine speeds is to target a single damper in the middle. The resulting damper has significant weight and provides inadequate torsional control over the entire range of vibrations so as to effect some degree of dampening at both torsional peaks.

The purpose of the present invention is to reduce torsional vibration on the crankshaft of an internal combustion engine. The dual mass damping device has two masses, both controlling torsional vibration. One mass controls vibration at a frequency affecting lower engine speeds while the second mass controls vibration at a frequency affecting higher engine speeds. Thus, the dual mass torsion damper better controls the crankshaft vibration than a single mass torsion damper. Another advantage of the invention is that the dual mass damper can be manufactured significantly lighter while better controlling torsional vibration than the prior art single mass torsion damper.

### BRIEF DESCRIPTION OF THE SEVERAL VIEWS OF THE DRAWING

Objects and advantages together with the operation of the invention may be better understood by reference to the following detailed description taken in connection with the following illustrations, wherein:

FIG. 1 is a cross-sectional view of the torsional vibration damper according to the preferred embodiment.

FIG. 2 is a graph showing the first and second modes of torsional vibration in an eight-cylinder engine with a typical single mass torsion damper installed on the crankshaft.

FIG. 3 is a graph showing the torsional vibration achieved when using an optimally tuned dual mass torsion damper.

### DETAILED DESCRIPTION OF THE INVENTION

Internal combustion engines of the kind that are in use today on various vehicles typically have a number of pistons connected to a crankshaft. The movement of the pistons caused by the explosion of the gases in the cylinders, rotates the crankshaft. One end of the crankshaft is connected to a transmission and drive train and is used to drive the wheels of the vehicle. The other end of the crankshaft (often called the “nose”) is positioned in the main bearing in the engine block and protrudes through the front wall or cover. A damper is typically attached to the nose of the crankshaft to dampen torsional vibrations.

The internal combustion engine transmits the linear motion of the pistons to torsional motion in the crankshaft. The detonations in each cylinder create the linear motion, but since they occur at different locations in terms of both rotational position and linear location of the crankshaft, they impart torsional vibrations into the crankshaft in addition to the rotational motion. The firing frequency of the engine acts as the primary excitation force of this torsional vibration.

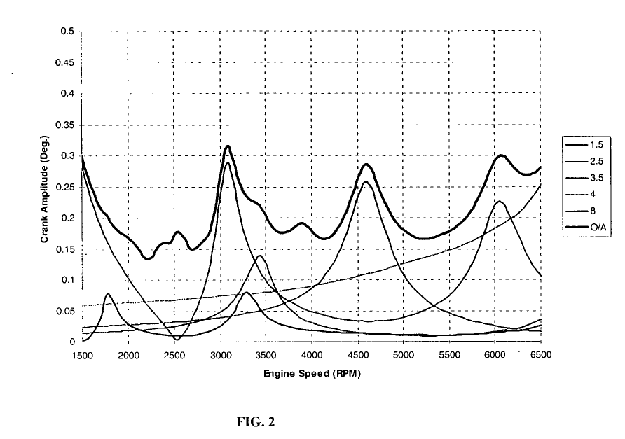

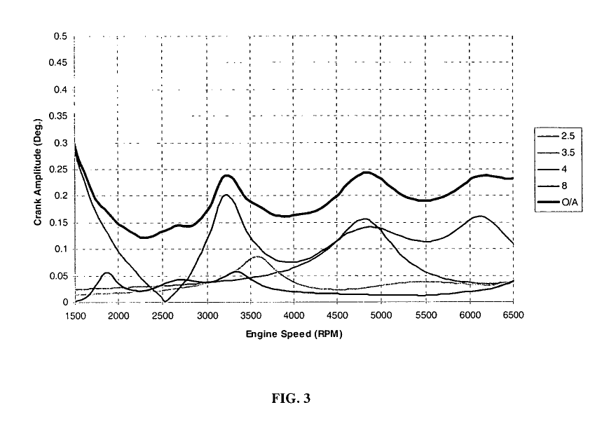

The order of the vibration refers to the number of times an event occurs during one rotation of the crankshaft. One full engine cycle incorporates two full rotations of the crankshaft on a four-stroke engine. Since each piston fires once during an engine cycle, only half of the pistons fire during a given crankshaft rotation. Therefore the order of the engine firing excitation equals one half the number of cylinders in the engine. FIGS. 2 and 3 shown the results of the orders of vibration, e.g. a fourth order vibration occurs four times during one full rotation of the crankshaft. O/A refers to the overall vibration level which is a root-mean-squared summation of the individual orders.

Every mechanical system has a natural frequency. The natural frequency of a given system is a function of the mass or inertia and the stiffness of the system. As the complexity of the system increases, the number of natural frequencies of the system also increases. These natural frequencies are also referred to as modes of vibration. When a system is exposed to disturbances or excitations at or near its natural frequency the resulting amplitude of vibration can grow large enough to cause damage to the system. The purpose of the damper is to control this vibration so it does not grow large enough to damage the system.

Historically, most engine applications did not reach a high enough engine speed to encounter more than the first mode or natural frequency. However, as engine speeds increase to reach higher levels of performance, the second mode can enter the engine operating speed range and cause a second vibration peak. FIG. 2 illustrates the first and second modes of torsional vibration in an eight-cylinder engine with a typical single mass torsion damper installed on the crankshaft.

The 4^{th} order drives most of the peak vibration. Two major peaks appear in the fourth order, one at roughly 3000 rpm and the second at 6000 rpm. The single mass damper was tuned to a frequency between the two peaks in an attempt to control the torsional vibration at both the first and second mode of the crankshaft. The damper applied in the previous graph provides nearly optimal tuning as the peaks of vibration are controlled to the same amplitude.

The current invention involves the process used to tune a dual mass torsion damper to better control crankshaft torsional vibration on an engine where both the first and second modes of vibration appear in the engine's operating speed range. FIG. 3 illustrates the torsional vibration achieved when using an optimally tuned dual mass torsion damper. The damper used in FIG. 3 weighed approximately three pounds less than the single mass torsion damper.

Therefore, optimal tuning is achieved by selecting the proper amount of inertia for each of the two inertia rings and by selecting the proper elastomer composition for each of the two elastomer members.

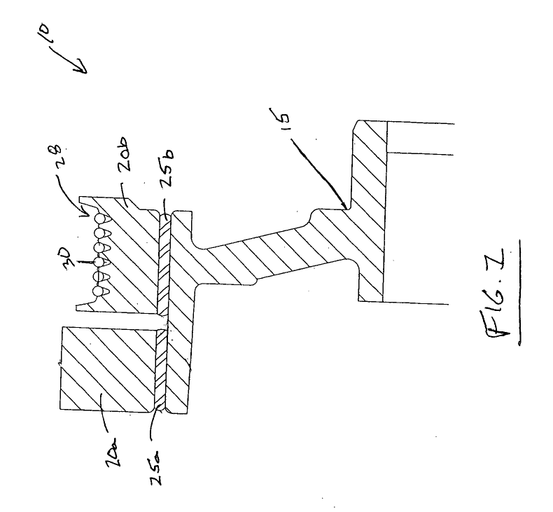

As best shown in FIG. 1, the torsional vibration damper 10 of the present invention generally comprises a hub 15, which can be attached to an engine's crankshaft, two inertia members 20a and 20b, which provide the inertia necessary to control crankshaft torsional vibration, and two elastomers 25a and 25b, which allow for proper tuning of the damper's torsional frequencies. The two masses 20a,20b and elastomer members 25a,25b allow for tuning two separate vibration frequencies, e.g. one for dampening one torsional peak and the other for dampening a second torsional peak. By creating a damper that accounts for these separate tuning frequencies, a more efficient use of inertia and thus a reduction in the mass of the damper assembly can be accomplished from those known in the prior art.

The hub 15 and inertia members 20a,20b are preferably made from metal materials, such as steel, cast iron, and aluminum. One common combination of materials utilizes automotive ductile cast iron (SAE J434) for the hub and automotive gray cast iron (SAE J431) for the inertia member. Another known combination of materials for the damper comprises die cast aluminum (SAE 308) for the hub and cast iron for the inertia member. The elastomer or resilient member 25a,25b may consist of natural rubber or a synthetic elastomeric composition as defined by specification SAE J200. Suitable synthetic elastomers include styrene butadiene rubber, isoprene rubber, nitrile rubber, ethylene propylene copolymer, and ethylene acrylic.

One of the inertia members may include a recessed belt track 28 in its outer surface for positioning of an engine belt 30. As shown in FIG. 1, inertia member 20b includes a recessed belt track 28. Accessories, such as the alternator, power steering compressor, and air conditioning compressor, are often driven off of such belt drives. It is understood that the design of many engines require the use of two or more belts, and that the present invention can be used in all of these engines, regardless of the number of belts actually utilized.

While numerous mounting arrangements can connect the damper 10 to a crankshaft, it is commonly known to tightly positioned the hub 15 of the damper 10 on the nose of crankshaft (not shown) by an interference fit. The hub 15 may also be keyed to the crankshaft with a metal key which fits within elongated slots in the hub and nose, respectively. A bolt and washer may also be used to secure the damper to the end of the crankshaft nose.

The construction of the damper 10 of the present invention allows assembly in a conventional way with conventional assembly tools and techniques. The hub 15 and inertia members 20a,20b are held in place in a jig or fixture (not shown) leaving an annular space for entry of the resilient members 25a,25b. The members 25a,25b are then formed into a ring shape and placed in an appropriate fixture over the annular space. Hydraulic or pneumatic pressure is then used to force the resilient members into the annular space.

The resilient members 25a,25b are preferably in a state of radial compression between the hub 15 and inertia members 20a,20b. The resilient members 25a,25b are stretched and changed in cross-section when they are forced into the annular space. The inherent resiliency of the rubber helps keep the members 25a,25b in place and the hub 15 and inertia members 20a,20b together. A bonding agent optionally can be applied to the surfaces of the resilient members 25a,25b prior to assembly, as is well known in the industry. The agent preferably is heat activated and, after the parts of the damper 10 are assembled, the damper 10 is subjected to heat sufficient to activate the bonding agent. This helps prevent the inertia members 20a,20b and hub 15 from shifting relative to one another during use, and also helps keep the resilient members 25a,25b in position.

The relationship of the mass moment of inertia of the inertia members 20a,20b and the stiffness of the resilient members 25a,25b determine the tuning frequency of the damper 10. The tuning frequency of the damper 10 represents the frequency at which the damper will most effectively dampen the torsional vibration of the crankshaft. A damper tuned to 225 Hz will most effectively dampen excitations occurring at a frequency of 225 Hz. The damper will also dampen excitations occurring at frequencies higher and lower than 225 Hz, but it's effectiveness will decrease as the excitation frequency moves further from the damper's tuning frequency.

The selection of the size, type and mass of the resilient material for the damper in order to reduce torsional vibrations is made in accordance with conventional techniques and standards. The damper is designed according to the particular engine involved. The frequency modes of the torsional vibrations of the crankshaft of the engine are either known from past experiences with the same or similar engines, are determined experimentally from a dynamic test of the engine, or are calculated by a computer using finite element analysis. Once this is determined, the size and inertia of the inertia member and the size and type of resilient material are selected and the damper design is then determined.

Although the preferred embodiment of the present invention has been illustrated in the accompanying drawings and described in the foregoing detailed description, it is to be understood that the present invention is not to be limited to just the preferred embodiment disclosed, but that the invention described herein is capable of numerous rearrangements, modifications and substitutions without departing from the scope of the claims hereafter.

Having thus described the invention, we claim:

1. A method of tuning with a damper a plurality of torsional vibration modes of an engine crankshaft, the damper comprising a central hub member, at least two outer inertia ring members, and a resilient material connecting each inertia ring member with the hub member, the method comprising the steps of:
preselecting a first inertia ring member having specified inertia;
preselecting a first band of resilient material having a cross-sectional area in the axial direction sufficient in cooperation with the character of resilience of the material to dampen a first mode of torsional vibration of the crankshaft when the band interconnects the first inertia member and the hub member;
preselecting a second inertia ring member having specified inertia; and
preselecting a second band of resilient material having a cross-sectional area in the axial direction sufficient in cooperation with the character of resilience of the material to dampen a second mode of torsional vibration of the crankshaft when the band interconnects the second inertia member and the hub member.

2. The method of claim 1 wherein the assembled damper is connected to the crankshaft.

3. The method of claim 2 wherein at least one of said first or second inertia ring members is adapted for connection to a belt drive.

4. The method of claim 3 wherein said resilient material is made from natural rubber.

5. The method of claim 3 wherein said resilient material is made from a synthetic elastomeric composition.

6. A damper for tuning a plurality of modes of torsional vibration of an engine crankshaft, the damper comprising:
a hub member for connection to the crankshaft;
a first inertia member spaced radially outwardly from said hub member;
a first resilient member positioned between said hub member and said first inertia member, said first resilient member having a cross-sectional area and chemical composition sufficient in cooperation with said first inertia member to dampen a first mode of torsional vibrations of the crankshaft;
a second inertia member spaced radially outwardly from said hub member; and
a second resilient member positioned between said hub member and said second inertia member, said second resilient member having a cross-sectional area and chemical composition sufficient in cooperation with said second inertia member to dampen a second mode of torsional vibrations of the crankshaft.

7. The damper of claim 6 wherein the assembled damper is connected to the crankshaft.

8. The damper of claim 7 wherein at least one of said first or second inertia ring members is adapted for connection to a belt drive.

9. The damper of claim 8 wherein said resilient material is made from natural rubber.

10. The damper of claim 8 wherein said resilient material is made from a synthetic elastomeric composition.

11. A torsional vibration damper for dampening a plurality of torsional vibration modes of an engine crankshaft, said damper comprising:
a hub member adapted for connection to a crankshaft;
a first inertia member spaced concentrically from the hub member;
a first resilient member situated between said hub member and said first inertia member for joining the hub and first inertia member together;
a second inertia member spaced concentrically from the hub member;
a second resilient member situated between said hub member and said second inertia member for joining the hub and second inertia member together;
wherein the first inertia member is sufficient in cooperation with the character of resilience of the first resilient member to dampen a first mode of torsional vibration of the crankshaft; and
wherein the second inertia member is sufficient in cooperation with the character of resilience of the second resilient member to dampen a second mode of torsional vibration of the crankshaft.

12. The damper of claim 11 wherein the assembled damper is connected to the crankshaft.

13. The damper of claim 12 wherein at least one of said first or second inertia ring members is adapted for connection to a belt drive.

14. The damper of claim 13 wherein said resilient material is made from natural rubber.

15. The damper of claim 13 wherein said resilient material is made from a synthetic elastomeric composition.
